(19) United States
(12) Patent Application Publication
(10) Pub. No.: US 2023/0136309 A1
(43) Pub. Date: May 4, 2023

(54) Virtual Assistant For Task Identification

(71) Applicant: Zoom Video Communications, Inc., San Jose, CA (US)

(72) Inventor: Melinda Min Xiao-Devins, Fremont, CA (US)

(21) Appl. No.: 17/514,500

(22) Filed: Oct. 29, 2021

(51) Int. Cl. G06Q 10/06; G06F 40/295; H04L 12/58; G06N 20/20

(52) U.S. Cl. CPC G06Q 10/06311; G06F 40/295; H04L 51/36; G06N 20/20

(57) ABSTRACT

A virtual assistant is configured to automatically identify tasks for a user by processing text from various applications of a unified communications platform (e.g., transcripts of conferences, voicemails, emails, and chat logs) to detect action items and infer associated action item data (e.g., task owner, location, and due date). For example, a virtual assistant system may be configured to utilize machine learning natural language understanding technology to extract action items from various input text to form a to-do list with due dates for the task owner. In some implementations, a two-tier machine learning model topology is used to identify action items in strings. The system may recognize named entities such as nouns, verbs, dates/times, locations of action item sentences. The output information may be displayed on a dashboard, in push notifications, or within other user interface aspects of a personal device, thus providing notification or task planning for personal assistance.

### FIELD

This disclosure relates to task identification using a virtual assistant.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a system for identifying tasks in text from various communication channels.

FIG. 5 is a block diagram of an example of a system for detecting action items in text from various communication channels.

FIG. 6 is an illustration of an example of a graphical user interface for presenting a task list for a user that has been extracted from text from various communication channels.

FIG. 7 is a flowchart of an example of a technique for task identification.

FIG. 8 is a flowchart of an example of a technique for detecting action items.

FIG. 9 is a flowchart of an example of a technique for identifying tasks in text from a second communication channel.

### DETAILED DESCRIPTION

A virtual assistant may be implemented as software in a software platform, such as a unified communications as a service (UCaaS) platform, that helps a user to organize and access their data. A user may send and receive information via a number of different communications channels within a UCaaS platform. It would be useful to have an automated summary of these communications, including a list of tasks or to-do items for a user. There is a technical challenge to automatically identify tasks for a user that are referenced in a variety of communications channels or formats. For example, different communication channels may exhibit different patterns of language (e.g., people may speak differently in a conference call than they would write about the same topics in an e-mail), thus designing a system capable of robustly identifying action items across many communication channels may be challenging.

Implementations of this disclosure address problems such as these by automatically identifying tasks for a user by processing text from various applications of a UCaaS platform (e.g., transcripts of conferences, voicemails, emails, and chat logs) to detect action items and infer associated action item data (e.g., task owner, location, and due date). For example, a virtual assistant system may be configured to utilize machine learning NLU (Natural Language Understanding) technology to extract action items from various input text to form a to-do list with due date for the task owner. The system may recognize named entities such as nouns, verbs, dates/times, locations of action item sentences. The output information may be displayed on a dashboard, in push notifications, or within other user interface aspects of a personal device, thus providing notification or task planning for personal assistance.

Text may be collected from various communication channels such as conference transcripts, chat messages, voicemail messages, or emails. In some implementations, a first machine learning based NLU model identifies and extracts action item sentences from the input text and forms a to-do list with entries based on these identified sentences. A second machine learning based NLU model recognizes named entities from each action item sentence and identifies elements such as a task owner, task item, location, due date/time, etc. A dashboard or other user interface software on a task owner's device extracts the information associated with the task owner, displays the tasks based on due date, and/or provides time-based notifications. For example, task data may be pulled by a user device for display or pushed to the user device in notifications. Examples of action items that could be identified and presented in a task list include calling a person regarding a topic, scheduling a meeting with a group of people, investigating a problem, and responding to an e-mail inquiry.

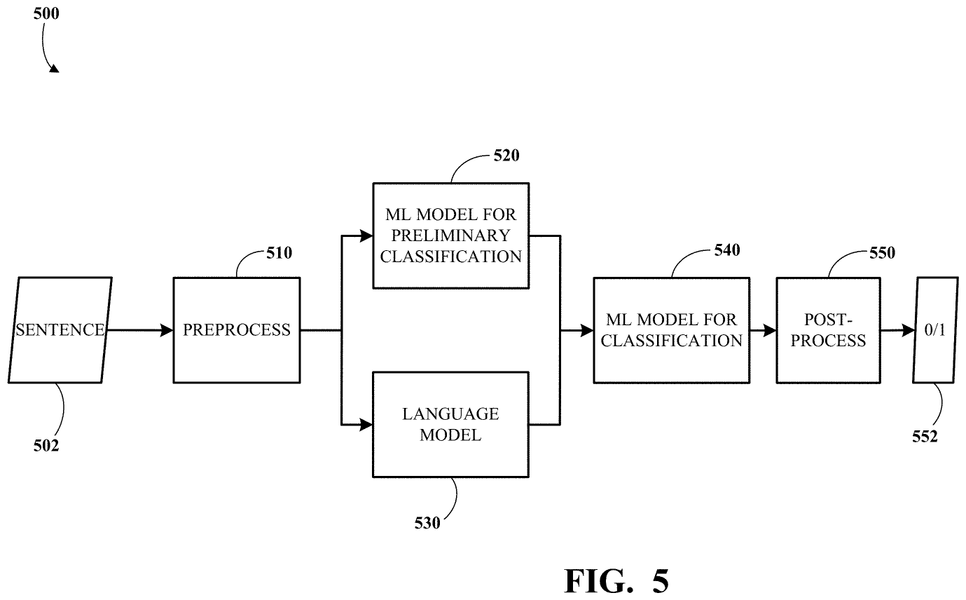

The first machine learning based NLU model may be trained to identify action item related sentences by classifying sentences as pertaining to an action item or not using a 2-tier Machine Learning Architecture for action item classification (e.g., the topology of constituent machine learning models shown in FIG. 5 that are used to identify sentences associated with action items). Input text may be broken down into strings (e.g., into sentences). A preprocessing software removes stop words from these strings. Feature extraction is performed on the strings, including: applying a 1st tier deep learning model, such as a Bidirectional Encoder Representations from Transformers (BERT) model to classify the string as concerning an action item (1) or non-action item (0); and a pre-trained model, such as the spaCy language model, identifies linguistic features, such as verb tenses, imperative sentences (starts with an action verb), requests, questions, etc. The features extracted from a string by these two models are fed into a 2nd tier machine learning model, such as an XGBoost model, which predicts whether the string corresponds to an action item or not with percentage of probability. A post processing layer uses a threshold of percentage to decide if the sting is an action item or not and return a binary classification of the string (e.g., a sentence).

The systems and techniques described herein may be utilized in a variety of use cases. In an example, transcripts from remote conferences may be processed to identify action items for various participants. In some implementations, text from other communication channels, such as telephone calls, e-mails, and chat sessions in a UCaaS may be processed to identify action items for various participants. In some implementations, all communications through a personal device (e.g., a smartphone) may be processed to identify action items for a user of the personal device. In some implementations, the task information may be output in different formats, such as task alerts when a new task is identified and reminders for a task as a due date approaches. In some implementations, voice commands to the virtual assistant that do not directly relate to a task list may be processed to infer information about tasks. In some implementations, relationships between users may be identified and tasks may be suggested to be added to to-do lists for users related to the owner of the task. In some implementations, the internet or other data sources may be scraped based on available task information to infer missing task information (e.g., a location or a date/time).

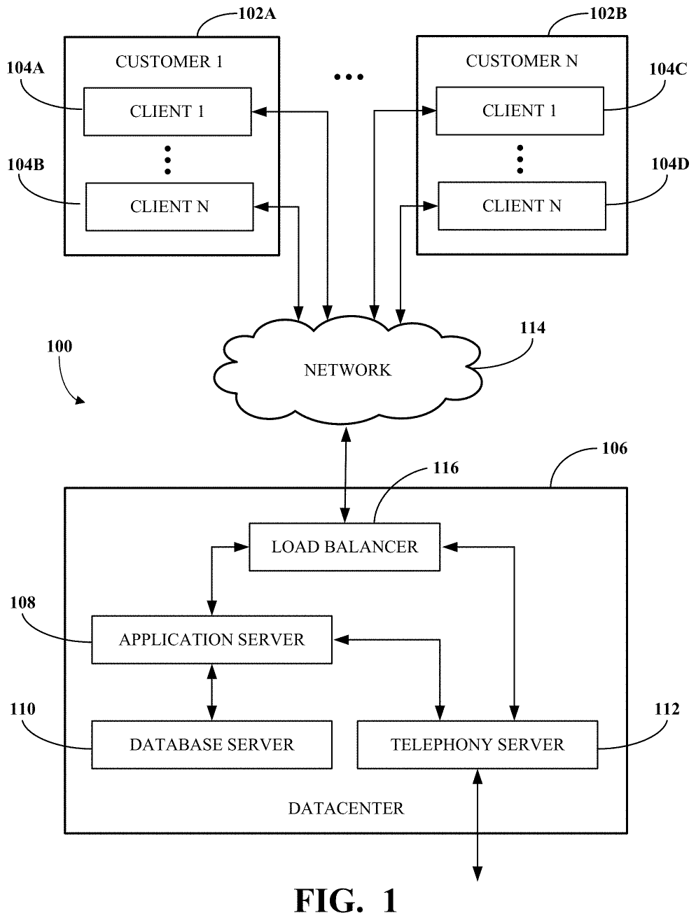

To describe some implementations in greater detail, reference is first made to examples of hardware and software structures used to implement a virtual assistant configured to identify tasks. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and to clients of a customer, such as the clients 104A through 104B for the customer 102A or the clients 104C through 104D for the customer 102B. Some or all of the clients 104A through 104D may be voice over internet protocol (VOIP)-enabled devices configured to send and receive calls over a network 114. In particular, the telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, an SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

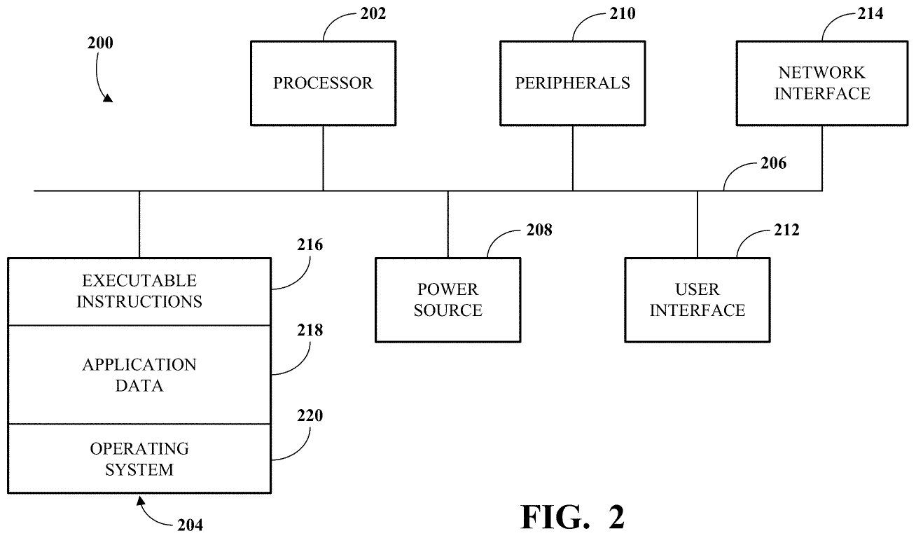

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

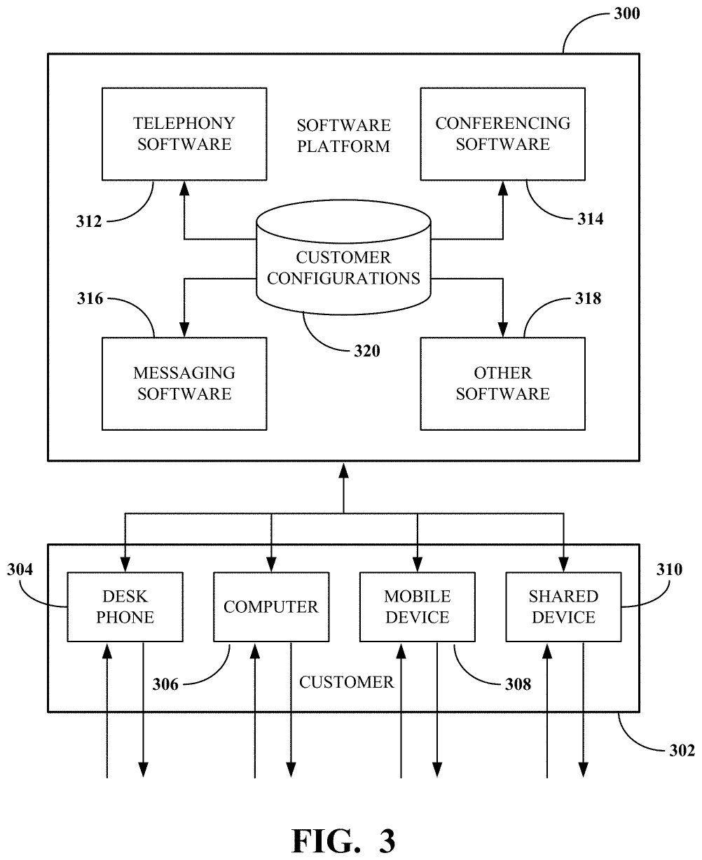

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients—a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include a virtual assistant for task identification.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

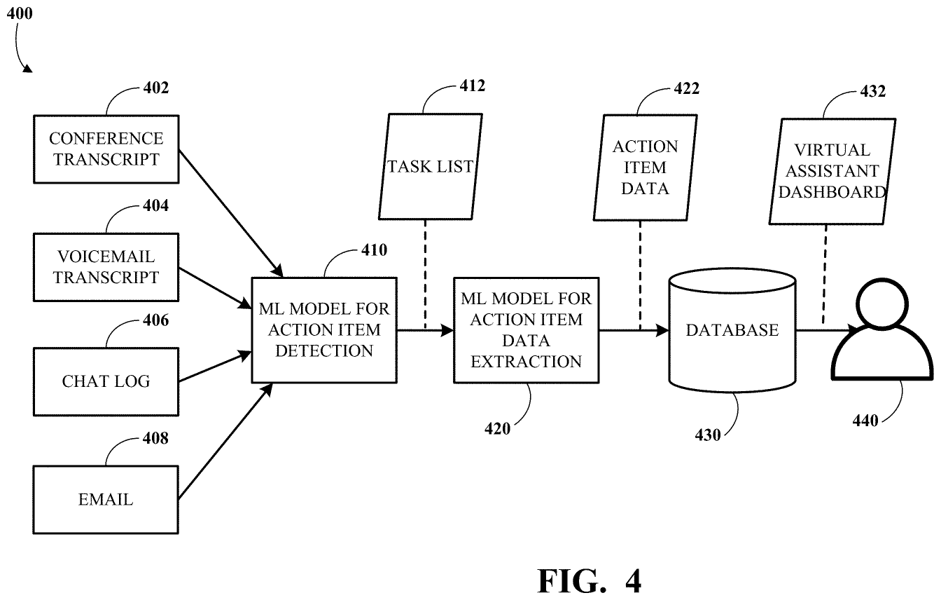

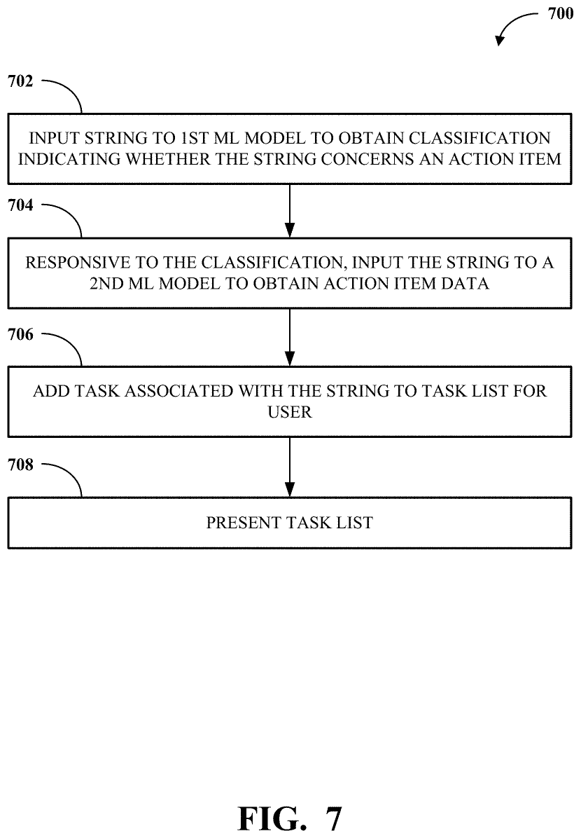

FIG. 4 is a block diagram of an example of a system 400 for identifying tasks in text from various communication channels. The system 400 includes a machine learning model 410 that has been trained to detect action items in strings of text from various sources, including a conference transcript 402, a voicemail transcript 404, a chat session log 406, and an email 408. The system 400 includes a machine learning model 420 that has been trained to extract action item data 422 from strings in a task list 412 that includes strings identified by the machine learning model 410 as concerning action items. The resulting task list 412 with associated action item data 422 for its entries is stored in a database 430. The system 400 is configured to search the task data stored in the database 430 for tasks associated with a user 440, based on their action item data 422, and present these tasks to the user 440 as part of a virtual assistant dashboard 432. For example, the system 400 may be used to implement the technique 700 of FIG. 7.

The system 400 includes a first machine learning model 410 for action item detection. Text may be collected from various communication channels such as the conference transcript 402 (e.g., a meeting transcript), the voicemail transcript 404, the chat log 406, or email 408. For example, text from these sources may be preprocessed to extract strings (e.g., sentences) that may be analyzed using one or more machine learning models such as a neural network. The machine learning model 410 may be trained to classify strings as either concerning an action item or not concerning an action item. The machine learning model 410 may also take metadata (e.g., a timestamp, a host identifier, a participant identifier, and telephone number, an email address, or an IP address) from a communication channel that is the source of a string as input that is used to classify the string. For example, the first machine learning model 410 may include the system 500 of FIG. 5. For example, the first machine learning model 410 may be implemented by the application server 108. In some implementations, the first machine learning model 410 may include NLU software configured to extract action item sentences from the input text, and form a task list 412 (e.g., a to-do list).

The system 400 includes a second machine learning model 420 for extracting action item data from strings that have been classified as concerning action items. The action item data may describe a task to be completed and/or enable the association of an action item with one or more users (e.g., a task owner), a due date, or a location. The action item data may be determined based on the contents of an action item string. In some implementations, the action item data is also determined based on metadata associated with the action item string, such as a conference participant identifier, a host identifier, a telephone number, an email address, and/or a timestamp. For example, the second machine learning model 420 may be implemented by the application server 108. In some implementations, the second machine learning model 420 may include NLU software configured to recognize named entities from each action item string, and identify a task owner, task item, location and/or due date/time. The resulting action item data may be associated with respective entries of the task list 412 and stored in a database 430. For example, the database 430 may be implemented using the database server 110.

The system 400 is configured to present information from a task list 412 to a relevant user 440. The information from the task list 412 may be presented in a virtual assistant dashboard 432. For example, the application server 108 may be configured to search a task list 412 stored in the database 430 for tasks relevant to the user 440 and present information about the relevant tasks in the virtual assistant dashboard 432. The virtual assistant dashboard 432 may include a graphical user interface that is presented to the user 440 by transmitting data encoding the virtual assistant dashboard 432 to a user device (e.g., the computer 306 or the mobile device 308) that the user 440 can use to view or otherwise access the virtual assistant dashboard 432. In some implementations, the virtual assistant dashboard 432 or another user interface software on a task owner's device extracts the information associated with the task owner, and displays the tasks based on due date, or provides time-based notifications.

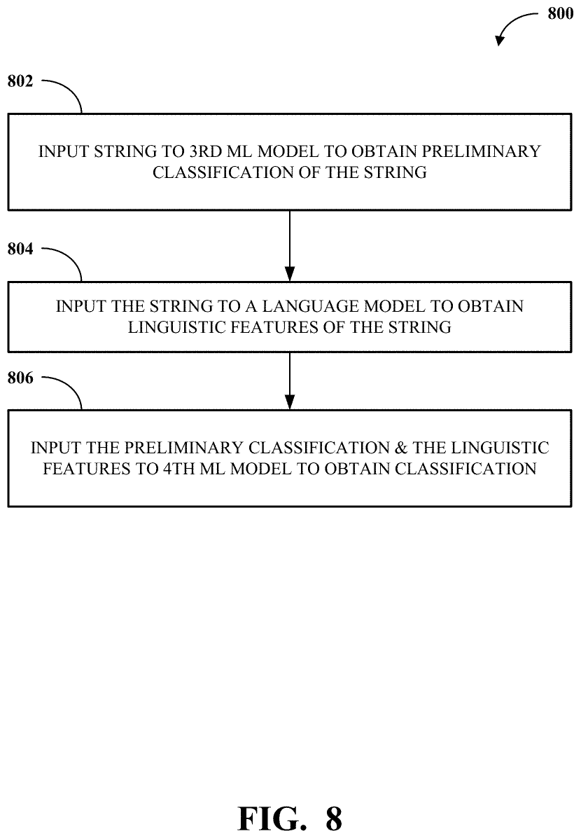

FIG. 5 is a block diagram of an example of a system 500 for detecting action items in text from various communication channels. The system 500 includes a preprocessing unit 510, a machine learning model 520 for preliminary classification of sentences as concerning an action item or not, a language model 530 configured to determine linguistic features of a sentence (e.g., the main verb and its tense), a machine learning model 540 configured to predict whether a sentence concerns an action item, and a post-processing unit 550 configured to map a prediction from the machine learning model 540 to a binary classification 552 of a sentence as concerning an action item or not. For example, the system 500 may be used to implement the technique 800 of FIG. 8. In some implementations, the system includes a two-tier machine learning architecture for action item classification.

The preprocessing unit 510 takes a sentence 502 as input. The sentence 502 may have been part of source of text (e.g., from a conference or phone transcript, a chat message, or an email) that has been broken down into strings corresponding to sentences. For example, the preprocessing unit 510 may include software configured to remove stop words (e.g., common words of a language that tend to convey little meaning, such as “the” or “a”) from the sentence 502.

The preprocessed sentence 502 is input to a machine learning model 520 for preliminary classification of the sentence 502 as concerning an action item or not concerning an action item. For example, the machine learning model 520 may include a 1st tier deep learning model, such as a BERT model, to classify the sentence 502 as action item (1) or non-action item (0). For example, the machine learning model 520 may be implemented by the application server 108.

The preprocessed sentence 502 is also input to a language model 530 to determine linguistic features of the sentence 502. For example, the linguistic features may include verb tenses, whether the sentence is an imperative sentence (i.e., starts with an action verb), a request, and/or a question. An action item sentence may contain a verb in present or future tense. In some implementations, the language model 530 may include a pre-trained model, such as the spaCy language model, in combination with linguistic rules to identify the linguistic features. For example, the language model 530 may be implemented by the application server 108.

The linguistic features and the preliminary classification are fed into a 2nd tier machine learning model 540 for classification. In some implementations, the machine learning model 540 includes an XGBoost model, which predicts whether the sentence is an action item or not with a percentage of probability. For example, the machine learning model 540 may be implemented by the application server 108.

The post-process unit 550 may be configured to map a prediction from the machine learning model 540 to a binary classification 552 of a sentence as concerning an action item or not concerning an action item. The post-process unit 550 may include post-process software that uses a threshold of percentage to decide if the sentence 502 describes an action item. If the sentence 502 is determined to concern an action item, then the sentence 502 may be added to a task data structure in a task list of detected tasks. The sentence 502 may then be further analyzed (e.g., using the machine learning model 420) to extract action item data from the sentence 502 and/or associated metadata.

A virtual assistant (also called digital assistant, or AI assistant) refers to an application program that performs tasks that are historically performed by a personal assistant or secretary. Such tasks may include taking dictation, reading text, placing phone calls, and reminding users about appointments. In some implementations, a virtual assistant provides unique values to users of a UCaaS platform (e.g., the software platform 300), since the UCaaS platform has an inherent advantage to extract intelligent information from various applications (e.g., conferencing, phone, chat, and email) via advanced NLP technology. For example, a UCaaS platform can utilize this information to assist users with tasks such as notifying action items, scheduling meetings, reminding user about due dates, and assisting with text or email.

Some examples of capabilities of a virtual assistant may include: automatically create to-do list and add items to the to-do list, allowing a user to modify the to-do list; automatically add events to a calendar, with user's confirmation; schedule meetings; generate notifications regarding action items on the to-do list; remind a user about due dates and times; prioritize chat messages; prioritize email; support voice command; narrate content; and answer questions.

Some examples of components of a virtual assistant are described below. A brain of a virtual assistant may include an AI powered NLP engine, which may extract text-based information, such as action items, or questions and identify named entities in a sentence, including who, action, whom, location, time and date. This intelligent information from various sources (meetings, phone transcripts, email, chat messages) can be associated with specific user(s) and form the user's personalized to-do list. A face of a virtual assistant may include a dashboard. A dashboard may give a virtual assistant a visual effect. The dashboard user interface may be integrated with existing UCaaS client, and may be configured to display the user's to-do list, upcoming meetings, unread emails, chat messages, missed phone calls, etc. The buttons or hyperlinks may serve two purposes: bring a user to other user interface with which the user can perform corresponding actions, such as replying to emails or text messaging, and placing phone calls; displaying the source where artificial intelligence components are used to extract the to-do list, such as meeting notes, meeting transcripts, chat messages, or emails. An ear of a virtual assistant may include a voice input command. Voice input may play an important role in a virtual assistant. A speech recognition software can convert voice command to text, then NLP can convert the text to commands, which can be acted upon by an application of a UCaaS platform. The following are some examples of voice input: “virtual assistant, schedule a meeting today at 2 pm with Mary” and “virtual assistant, what is my to-do list today?” A mouth of a virtual assistant may include a narrator. A text to speech narration software can answer simple questions such as “What is my to-do list today?” or giving execution results for the user's voice. Commands, such as “You have successfully scheduled a meeting with Mary on 2 pm”. A virtual assistant may also enable dictation of an email or text message.

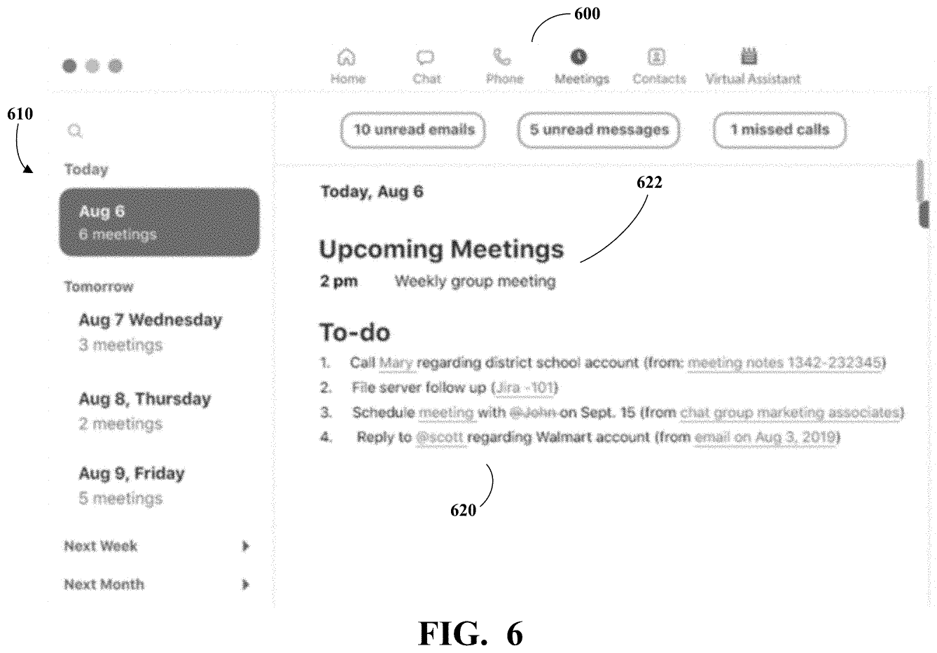

FIG. 6 is an illustration of an example of a graphical user interface 600 for presenting a task list for a user that has been extracted from text from various communication channels. The graphical user interface 600 includes a side-panel 610 listing tasks from a user's to-do list occurring within various windows of time including today, tomorrow next week, and next month. The lists for each of these periods of time may be collapsible and expandable using an icon of the graphical user interface 600. The side-panel 610 may display abbreviated summaries of tasks and meetings on different days and enable the selection (e.g., by interacting with an icon using a mouse or touchscreen) of a day for more detailed examination in a main panel of the graphical user interface 600. The main panel of the graphical user interface 600 includes a to-do list 620 with entries for various tasks of the selected day with associated action item data for each task. The main panel of the graphical user interface 600 also includes a list of upcoming meetings 622 for the selected day with time and location/connection information for the meetings. The graphical user interface 600 may include links to other applications of a UCaaS platform.

To further describe some implementations in greater detail, reference is next made to examples of techniques which may be performed by or using a virtual assistant for task identification. FIG. 7 is a flowchart of an example of a technique 700 for task identification. The technique 700 can be executed using computing devices, such as the systems, hardware, and software described with respect to FIGS. 1-6. The technique 700 can be performed, for example, by executing a machine-readable program or other computer-executable instructions, such as routines, instructions, programs, or other code. The steps, or operations, of the technique 700 or another technique, method, process, or algorithm described in connection with the implementations disclosed herein can be implemented directly in hardware, firmware, software executed by hardware, circuitry, or a combination thereof.

For simplicity of explanation, the technique 700 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

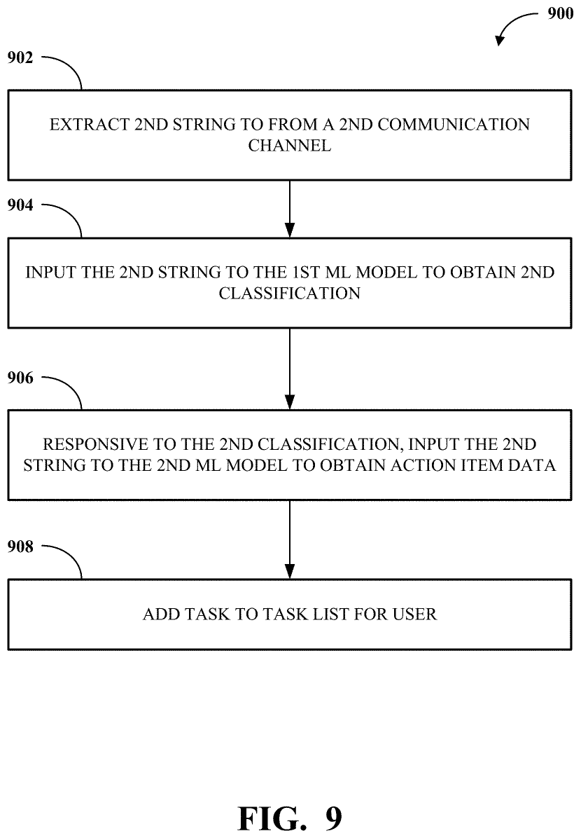

At 702, the technique 700 includes inputting a string to a first machine learning model (e.g., the machine learning module 410) to obtain a classification indicating whether the string concerns an action item. The string may be a sentence that has been extracted from a text data source. In some implementations, the data source for the string is a communication channel of a UCaaS platform (e.g., a conference, a phone call, a voicemail, an email, or a chat). For example, the string may be extracted from a transcript of a conference. The technique 700 may be applied to strings from multiple different communication channels. For example, the technique 700 may include the technique 900 of FIG. 9. The first machine learning model may be trained to classify a string as either concerning an action item or as not concerning an action item. In some implementations, the first machine learning model uses a two-tier topology of machine learning models to determine features of the string and detect whether the string concerns an action item based on those features. In some implementations, the features include linguistic features of the string that indicate whether the string includes an imperative sentence. For example, the first machine learning model may include the system 500 of FIG. 5. For example, the technique 800 of FIG. 8 may be implemented at step 702.

At 704, the technique 700 includes, responsive to the classification indicating that the string concerns an action item, inputting the string to a second machine learning model to obtain action item data including a user identifier. The action item data may include identification of one or more users responsible for or otherwise associated with a task corresponding to the string, a time or date when the task must be completed, a location associated with the task, and/or other data specifying the nature or parameters of the task. For example, the second machine learning model may include the machine learning model 420 of FIG. 4. In some implementations, the second machine learning model also takes as input metadata (e.g., an IP address, a telephone number, an email address, a username, and/or a timestamp) of a communication channel from which the string was taken. For example, the technique 700 may include inputting communication metadata to the second machine learning model. The communication metadata may include a participant identifier associated with the string (e.g., a participant identifier for a speaker associated with the string in a transcript of a conference). The second machine learning model may include NLU software trained to recognize named entities in the string, and identify corresponding parameters of a task based on these named entities. For example, the second machine learning model may be trained to recognize a task owner, a task item, a location, and/or a due date/time for a task associated with the string (e.g., a sentence).

At 706, the technique 700 includes, based on the user identifier, adding a task associated with the string to a task list for a user associated with the user identifier (e.g., a host identifier, a participant identifier, a phone number, or an email address). A user may have a list of tasks that is automatically updated as new tasks are described in communications in a UCaaS platform.

At 708, the technique 700 includes presenting the task list. The task list may be presented in a user interface (e.g., a webpage). For example, the task list may be presented in the graphical user interface 600 as part of a virtual assistant dashboard. In some implementations, the task list may be presented by transmitting the task list as part of a graphical user interface using a network interface (e.g., the network interface 214). The task list may be transmitted to a device (e.g., the agent device 414 or the supervisor device 418) that can be used by a user to view the task list. In some implementations, the task list may be presented by displaying the task list on a local peripheral (e.g., a monitor, a touchscreen, or other display device).

FIG. 8 is a flowchart of an example of a technique 800 for detecting action items. The technique 800 can be executed using computing devices, such as the systems, hardware, and software described with respect to FIGS. 1-6. The technique 800 can be performed, for example, by executing a machine-readable program or other computer-executable instructions, such as routines, instructions, programs, or other code. The steps, or operations, of the technique 800 or another technique, method, process, or algorithm described in connection with the implementations disclosed herein can be implemented directly in hardware, firmware, software executed by hardware, circuitry, or a combination thereof.

For simplicity of explanation, the technique 800 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The first machine learning model of the technique 700 may include a third machine learning model, a language model, and a fourth machine learning model. These components of the first machine learning model may be arranged in a two-tier topology (e.g., as shown in FIG. 5).

At 802, the technique 800 includes inputting the string to the third machine learning (e.g., the machine learning model 520) model to obtain a preliminary classification of the string indicating whether the string concerns an action item. For example, the third machine learning model may include a BERT model. In some implementations, the string is preprocessed before it is passed into the third machine learning model (e.g., preprocessed to remove stop words from the string).

At 804, the technique 800 includes inputting the string to the language model (e.g., the language model 530) to obtain linguistic features of the string. For example, the linguistic features may include verb tenses, whether the sentence is an imperative sentence (i.e., starts with an action verb), a request, and/or a question. In some implementations, the language model may include a pre-trained model, such as the spaCy language model, that identifies the linguistic features. In some implementations, the linguistic features indicate whether the string includes an imperative sentence.

At 806, the technique 800 inputting the preliminary classification and the linguistic features to the fourth machine learning model (e.g., the machine learning model 540) to obtain the classification indicating whether the string concerns an action item. In some implementations, the fourth machine learning model includes an XGBoost model, which predicts whether the string is an action item or not with a percentage of probability. A prediction from the fourth machine learning model may be mapped (e.g., using a threshold percentage) to a binary classification of the string as concerning an action item or not concerning an action item.

FIG. 9 is a flowchart of an example of a technique 900 for identifying tasks in text from a second communication channel. The technique 900 can be executed using computing devices, such as the systems, hardware, and software described with respect to FIGS. 1-6. The technique 900 can be performed, for example, by executing a machine-readable program or other computer-executable instructions, such as routines, instructions, programs, or other code. The steps, or operations, of the technique 900 or another technique, method, process, or algorithm described in connection with the implementations disclosed herein can be implemented directly in hardware, firmware, software executed by hardware, circuitry, or a combination thereof.

For simplicity of explanation, the technique 900 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The string analyzed using the technique 700 may be a first string that is extracted from a first communication channel and strings from other types of communication channels may also be analyzed to identify tasks. In this manner, multiple communication channels used by a user or a group of users may be automatically monitored to identify new tasks for users.

At 902, the technique 900 includes extracting a second string from a second communication channel that is different from the first communication channel. In some implementations, the first communication channel is a conference, and the second communication channel is an e-mail. For example, the communications channels monitored may include a conference, a phone call, a voicemail, email, and/or chat. Text may be extracted from various communication channels with an audio component by applying speech recognition processing to an audio recording of communications to obtain a transcript of the audio and then extracting strings (e.g., sentences) from the transcript.

At 904, the technique 900 includes inputting the second string to the first machine learning model to obtain a second classification indicating whether the second string concerns an action item. The first machine learning model may be trained using labels from multiple types of communication channels, which may serve to make the first machine learning model robust to variations in speech patterns across different communication channels.

At 906, the technique 900 includes, responsive to the second classification indicating that the second string concerns an action item, inputting the second string to the second machine learning model to obtain action item data including a second identifier of an owner of a task. The second machine learning model may be trained using labels from multiple types of communication channels, which may serve to make the second machine learning model robust to variations in speech patterns across different communication channels.

At 908, the technique 900 includes adding the task to a task list for a user associated with the second identifier.

One aspect of this disclosure is a method comprising inputting a string to a first machine learning model to obtain a classification indicating whether the string concerns an action item; responsive to the classification indicating that the string concerns an action item, inputting the string to a second machine learning model to obtain action item data including a user identifier; and adding the action item to a task list for a user associated with the user identifier.

One aspect of this disclosure is a system comprising a processor and a memory, wherein the memory stores instructions executable by the processor to input a string to a first machine learning model to obtain a classification indicating whether the string concerns an action item; responsive to the classification indicating that the string concerns an action item, input the string to a second machine learning model to obtain action item data including a user identifier; and add the action item to a task list for a user associated with the user identifier.

One aspect of this disclosure is a non-transitory computer-readable storage medium, comprising executable instructions that, when executed by a processor, facilitate performance of operations, comprising inputting a string to a first machine learning model to obtain a classification indicating whether the string concerns an action item; responsive to the classification indicating that the string concerns an action item, inputting the string to a second machine learning model to obtain action item data including a user identifier; and adding the action item to a task list for a user associated with the user identifier.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as Python, C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a few conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

1. A method comprising:
extracting a string from a communication channel of a Unified Communications as a Service (UCaaS) platform;
inputting the string to a first machine learning model to obtain a classification indicating whether the string concerns an action item;
responsive to the classification indicating that the string concerns an action item, inputting the string to a second machine learning model to obtain action item data including a user identifier; and
adding a task, specified by the action item data and associated with the string, to a task list for a user associated with the user identifier.

2. The method of claim 1, wherein the first machine learning model includes a third machine learning model, a language model, and a fourth machine learning model, the method comprising:
inputting the string to the third machine learning model to obtain a preliminary classification of the string indicating whether the string concerns an action item;
inputting the string to the language model to obtain linguistic features of the string; and inputting the preliminary classification and the linguistic features to the fourth machine
learning model to obtain the classification indicating whether the string concerns an action item.

3. The method of claim 2, wherein the linguistic features indicate whether the string includes an imperative sentence.

4. The method of claim 1, comprising:
extracting the string from a transcript of a conference.

5. The method of claim 1, comprising:
inputting communication metadata to the second machine learning model, wherein the communication metadata includes a participant identifier associated with the string.

6. The method of claim 1, wherein the string is a first string that is extracted from a first communication channel and the task is a first task, and comprising:
extracting a second string from a second communication channel that is different from the first communication channel;
inputting the second string to the first machine learning model to obtain a second classification indicating whether the second string concerns an action item;
responsive to the second classification indicating that the second string concerns an action item, inputting the second string to the second machine learning model to obtain action item data including a second identifier of an owner of a second task; and
adding the second task to a task list for a user associated with the second identifier.

7. The method of claim 6, wherein the first communication channel is a conference, and the second communication channel is an e-mail.

8. A system comprising:
a processor, and
a memory, wherein the memory stores instructions executable by the processor to:
extract a string from a communication channel of a Unified Communications as a Service (UCaaS) platform,
input the string to a first machine learning model to obtain a classification indicating whether the string concerns an action item;
responsive to the classification indicating that the string concerns an action item, input the string to a second machine learning model to obtain action item data including a user identifier; and
add a task, specified by the action item data and associated with the string, to a task list for a user associated with the user identifier.

9. The system of claim 8, wherein the first machine learning model includes a third machine learning model, a language model, and a fourth machine learning model, and the memory stores instructions executable by the processor to:
input the string to the third machine learning model to obtain a preliminary classification of the string indicating whether the string concerns an action item;
input the string to the language model to obtain linguistic features of the string; and
input the preliminary classification and the linguistic features to the fourth machine learning model to obtain the classification indicating whether the string concerns an action item.

10. The system of claim 9, wherein the linguistic features indicate whether the string includes an imperative sentence.

11. The system of claim 8, wherein the memory stores instructions executable by the processor to:
extract the string from a transcript of a conference.

12. The system of claim 8, wherein the memory stores instructions executable by the processor to:
input communication metadata to the second machine learning model, wherein the communication metadata includes a participant identifier associated with the string.

13. The system of claim 8, wherein the string is a first string that is extracted from a first communication channel and the task is a first task, and the memory stores instructions executable by the processor to:
extract a second string from a second communication channel that is different from the first communication channel;
input the second string to the first machine learning model to obtain a second classification indicating whether the second string concerns an action item;
responsive to the second classification indicating that the second string concerns an action item, input the second string to the second machine learning model to obtain action item data including a second identifier of an owner of a second task; and
add the second task to a task list for a user associated with the second identifier.

14. The system of claim 13, wherein the first communication channel is a conference, and the second communication channel is an e-mail.

15. A non-transitory computer-readable storage medium, comprising executable instructions that, when executed by a processor, facilitate performance of operations, comprising:
extracting a string from a communication channel of a Unified Communications as a Service (UCaaS) platform;
inputting the string to a first machine learning model to obtain a classification indicating whether the string concerns an action item;
responsive to the classification indicating that the string concerns an action item, inputting the string to a second machine learning model to obtain action item data including a user identifier; and
adding a task, specified by the action item data and associated with the string, to a task list for a user associated with the user identifier.

16. The non-transitory computer-readable storage medium of claim 15, wherein the first machine learning model includes a third machine learning model, a language model, and a fourth machine learning model, the operations comprising:
inputting the string to the third machine learning model to obtain a preliminary classification of the string indicating whether the string concerns an action item;
inputting the string to the language model to obtain linguistic features of the string; and
inputting the preliminary classification and the linguistic features to the fourth machine learning model to obtain the classification indicating whether the string concerns an action item.

17. The non-transitory computer-readable storage medium of claim 16, wherein the linguistic features indicate whether the string includes an imperative sentence.

18. The non-transitory computer-readable storage medium of claim 15, the operations comprising:
extracting the string from a transcript of a conference.

19. The non-transitory computer-readable storage medium of claim 15, the operations comprising:
inputting communication metadata to the second machine learning model, wherein the communication metadata includes a participant identifier associated with the string.

20. The non-transitory computer-readable storage medium of claim 15, wherein the string is a first string that is extracted from a first communication channel and the task is a first task, and the operations comprising:
extracting a second string from a second communication channel that is different from the first communication channel;
inputting the second string to the first machine learning model to obtain a second classification indicating whether the second string concerns an action item;
responsive to the second classification indicating that the second string concerns an action item, inputting the second string to the second machine learning model to obtain action item data including a second identifier of an owner of a second task; and
adding the second task to a task list for a user associated with the second identifier.
